(19) United States
(12) Patent Application Publication
(10) Pub. No.: US 2022/0292982 A1
(43) Pub. Date: Sep. 15, 2022

(54) METHOD FOR SORTING VEHICLES OF VEHICLE PLATOONS

(71) Applicant: Ningbo Geely Automobile Research & Development Co., Ltd., Ningbo (CN)

(72) Inventors: Magnus BRANDIN, Mölnlycke (SE); Markus BÖLANDER, Göteborg (SE); Markus SÖDERLUND, Lerum (SE)

(21) Appl. No.: 17/680,573

(22) Filed: Feb. 25, 2022

Related U.S. Application Data
(63) Continuation of application No. PCT/CN2020/111876, filed on Aug. 27, 2020.

(30) Foreign Application Priority Data
Sep. 2, 2019 (EP) 19194924.7

(51) Int. Cl. G08G 1/00; B60W 30/18; B60W 30/165; G05D 1/02

(52) U.S. Cl. CPC G08G 1/22; G08G 1/20; B60W 30/18163; B60W 30/165; G05D 1/0293; G05D 1/0295; B60W 2554/802; G05D 2201/0213

(57) ABSTRACT

A method for sorting vehicles of vehicle platoon includes providing a first vehicle platoon driving along a first route and a second vehicle platoon driving along a second route, where the first vehicle platoon has a lead vehicle and a plurality of following vehicles and the second vehicle platoon has a lead vehicle and a plurality of following vehicles. The method selects a road segment in common to the first route and the second route, and controls at least one following vehicle of the first vehicle platoon to leave the first vehicle platoon and join the second vehicle platoon, and/or controls at least one following vehicle of the second vehicle platoon to leave the second vehicle platoon and join the first vehicle platoon, while driving the first vehicle platoon and the second vehicle platoon along said road segment.

### RELATED APPLICATION DATA

This application is a continuation of International Patent Application No. PCT/CN2020/111876, filed Aug. 27, 2020, which claims the benefit of European Patent Application No. 19194924.7, filed Sep. 2, 2019, the disclosures of which are incorporated herein by reference in their entireties.

### TECHNICAL FIELD

The invention relates to a method for sorting vehicles of vehicle platoons and a control arrangement for controlling vehicles of vehicle platoons.

### BACKGROUND

In a traffic system comprising vehicle platoons, where each vehicle platoon has a lead vehicle and a plurality of following vehicles driving in a convoy after the lead vehicle, there is a need for individual vehicles to change from one vehicle platoon to another vehicle platoon for reaching the planned destination. The connection and disconnection of vehicles to/from a vehicle platoon should however be performed without disturbances leading to delays and longer driving times.

### SUMMARY

An objective of the invention is to provide a method for sorting vehicles of vehicle platoons, by which method connection and disconnection of vehicles to/from a vehicle platoon can be performed in an efficient way.

The objective is achieved by a method for sorting vehicles of vehicle platoons, where the method comprises the steps of providing a first vehicle platoon driving along a first route and a second vehicle platoon driving along a second route, wherein the first vehicle platoon comprises a lead vehicle and a plurality of following vehicles and the second vehicle platoon comprises a lead vehicle and a plurality of following vehicles, and selecting a road segment in common to the first route and the second route, and controlling at least one following vehicle of the first vehicle platoon to leave the first vehicle platoon and join the second vehicle platoon, and/or controlling at least one following vehicle of the second vehicle platoon to leave the second vehicle platoon and join the first vehicle platoon, while driving the first vehicle platoon and the second vehicle platoon along said road segment.

The invention is based on the insight that by such method, vehicles having same planned destination but initially are driving in different vehicle platoons can join the same vehicle platoon while keeping a significant velocity of the vehicle platoons, and then continue towards the planned destination.

According to one embodiment of the method, the method comprises the steps of driving the first vehicle platoon in a first lane of the road segment and driving the second vehicle platoon in a second lane of the road segment, and positioning the first vehicle platoon and the second vehicle platoon relative to each other such that a rear end of the second vehicle platoon is in front of said at least one following vehicle of the first vehicle platoon, controlling said at least one following vehicle of the first vehicle platoon to change from the first lane to the second lane and join the second vehicle platoon at the rear end of the second vehicle platoon, and, the method preferably comprises the steps of repositioning the first vehicle platoon and the second vehicle platoon relative to each other such that a rear end of the first vehicle platoon is in front of said at least one following vehicle of the second vehicle platoon, controlling said at least one following vehicle of the second platoon to change from the second lane to the first lane and join the first vehicle platoon at the rear end of the first vehicle platoon. Hereby, the energy consumption can be kept low at the same time as the sorting of vehicles can be performed in a relatively short time.

According to a further embodiment, the method comprises the steps of performing the lane change of said at least one following vehicle of the first vehicle platoon, and thereafter the lane change of said at least one following vehicle of the second vehicle platoon, during an overtaking where the first vehicle platoon passes the second vehicle platoon. Hereby, no additional braking consuming energy is required for performing sorting of the vehicles.

According to a further embodiment, the method comprises the steps of driving the first vehicle platoon in a first lane of the road segment and driving the second vehicle platoon in a second lane of the road segment, side by side, providing a distance between a first following vehicle and a second following vehicle of the second vehicle platoon, for receiving a following vehicle therebetween at a position corresponding to the longitudinal position of said at least one following vehicle of the first vehicle platoon, controlling said at least one following vehicle of the first vehicle platoon to change from the first lane to the second lane and join the second vehicle platoon between the first following vehicle and the second following vehicle of the second vehicle platoon, and, the method preferably comprises the steps of providing a distance between a first following vehicle and a second following vehicle of the first vehicle platoon, for receiving a following vehicle therebetween at a position corresponding to the longitudinal position of said at least one following vehicle of the second vehicle platoon, controlling said at least one following vehicle of the second vehicle platoon to change from the second lane to the first lane and join the first vehicle platoon between the first following vehicle and the second following vehicle of the first vehicle platoon. Hereby, vehicles can change from one vehicle platoon to any position of another vehicle platoon.

According to a further embodiment, the method comprises the steps of performing the lane change of said at least one following vehicle of the first vehicle platoon and the lane change of said at least one following vehicle of the second vehicle platoon by zipper merging said at least one following vehicle of the first vehicle platoon and said at least one following vehicle of the second vehicle platoon. Hereby, vehicles from two vehicle platoons can be sorted laterally at the same time in an efficient way.

According to another aspect of the invention, a further objective is to provide a control arrangement for controlling vehicles of vehicle platoons, by which control arrangement connection and disconnection of vehicles to/from a vehicle platoon can be performed in an efficient way.

This objective is achieved by a control arrangement for controlling vehicles of vehicle platoons, where the vehicle platoons comprises a first vehicle platoon driving along a first route and a second vehicle platoon driving along a second route, and the first vehicle platoon comprises a lead vehicle and a plurality of following vehicles and the second vehicle platoon comprises a lead vehicle and a plurality of following vehicles, where the control arrangement is configured to select a road segment in common to the first route and the second route, and to control at least one following vehicle of the first vehicle platoon to leave the first vehicle platoon and join the second vehicle platoon, and/or control at least one following vehicle of the second vehicle platoon to leave the second vehicle platoon and join the first vehicle platoon, while the first vehicle platoon and the second vehicle platoon are driving along said road segment.

The advantages of the control arrangement are similar to the advantages already discussed hereinabove with reference to the different embodiments of the method.

Further advantages and advantageous features of the invention are disclosed in the following description and in the claims.

### BRIEF DESCRIPTION OF THE DRAWINGS

With reference to the appended drawings, below follows a more detailed description of embodiments of the invention cited as examples.

In the drawings:

FIG. 1 shows a vehicle platoon,

FIG. 2 shows two vehicle platoons driving in different lanes,

FIG. 3 is a map showing some routes for vehicle platoons,

FIGS. 4A, 4B, 4C and 4D show a road segment and an example embodiment of sorting following vehicles of two vehicle platoons, and

FIGS. 5A, 5B, 5C and 5D show a road segment and a further example embodiment of sorting following vehicles of two vehicle platoons.

### DETAILED DESCRIPTION

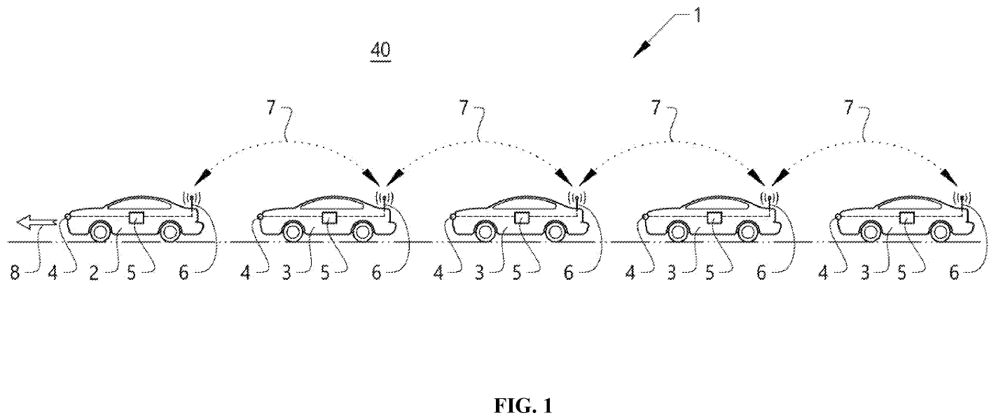

FIG. 1 shows a vehicle platoon 1 having a lead vehicle 2 and a plurality of following vehicles 3. The lead vehicle 2 and the following vehicles 3 are individual vehicles but driven together as a group or convoy. The following vehicles 3 are positioned in a line after the lead vehicle 2. The driving direction is indicated with an arrow 8. The lead vehicle 2 can be a so called autonomous or self-driving vehicle, or the lead vehicle 2 can be at least partly controlled by an operator of the lead vehicle. The following vehicles 3 of the vehicle platoon are suitably automatically controlled without any driver assistance.

When driving in the vehicle platoon 1, the following vehicles 3 are controlled to follow the lead vehicle 2 or the vehicle closest to the front, such that when the speed of the lead vehicle 2 is increased/decreased the speed of the following vehicles 3 is increased/decreased correspondingly for maintaining or achieving the desired distances and time gaps between the vehicles. Further, when the lead vehicle 2 is changing driving direction, a following vehicle 3 will also change driving direction and follow the lead vehicle or rather the vehicle closest to the front.

For enabling the vehicles 2, 3 to be controlled, each vehicle can be provided with any suitable sensor equipment 4 for receiving information about the environment, and a control unit 5 for controlling the vehicle. The sensor equipment gives information about at least the vehicle closest to the front, but preferably the sensor equipment is covering 360 degrees around the vehicle for obtaining the information that is required for longitudinal and lateral control of the vehicle. Such sensor equipment 4 may comprise LIDAR, radar and ultrasonic sensors, cameras, etc. The information received by the sensor equipment is used by the control unit 5 for controlling the driving behaviour of the vehicle. In addition, maps, GPS, etc., can be used for determining the current position of a vehicle platoon or an individual vehicle of a vehicle platoon.

Alternatively or in addition to the sensor equipment 4, each vehicle 2, 3 is provided with a communication unit 6 for communicating with one or more of the other vehicles of the vehicle platoon 1. Such a communication unit 6 may comprise any suitable components for establish communication between the vehicles. For example, the communication unit 6 may comprise a transmitter and a receiver based on radio waves or microwaves. In other words, each vehicle can be part of a local network for communication 7 between the vehicles of the vehicle platoon 1. By means of the local network, control signals can be transmitted from one vehicle to another vehicle. The control signals received are then used by the control unit 5 arranged on the vehicle for controlling the driving behaviour of the vehicle. Such control signals received by the following vehicles 3 are preferably at least initially transmitted by the lead vehicle 2.

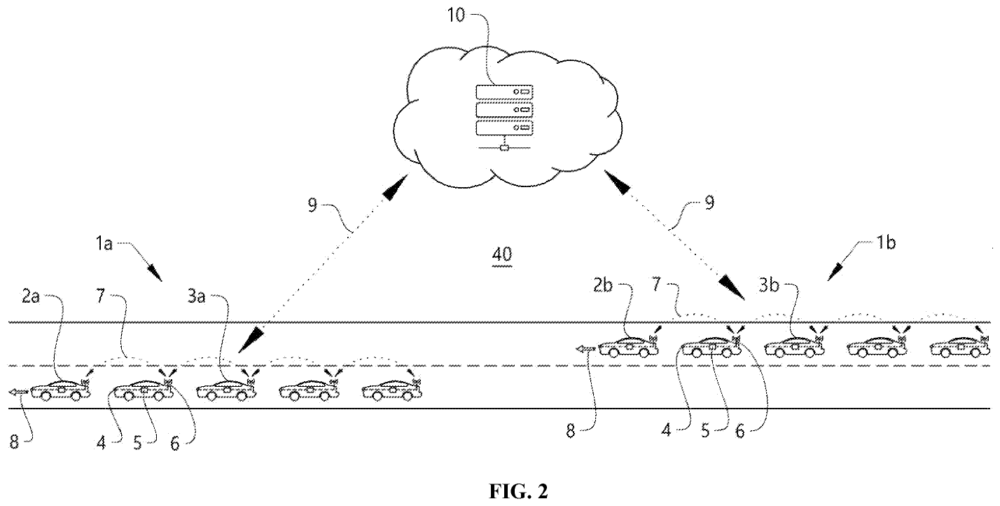

FIG. 2 shows two vehicle platoons 1a, 1b driving in different lanes of a road. Each vehicle platoon 1a, 1b of the current traffic system is also part of a central network for communication 9 between the vehicle platoon 1a, 1b and a central control unit 10. By means of the central network, control signals can be transmitted from the central control unit 10 to a vehicle platoon 1a, 1b for controlling the driving behaviour of the vehicle platoon. Such control signals are preferably received by the lead vehicle 2a, 2b of the vehicle platoon, but could also be received by one or more of the following vehicles 3 of the vehicle platoon. The central control unit 10 can be part of a server of a wireless network, such as Internet, for cloud computing.

The central control unit 10 and the local control unit 5 arranged on a vehicle may comprise one or more microprocessors and/or one or more memory devices or any other components for executing computer programs to perform the method described hereinafter. Thus, the central control unit and/or the local control unit is preferably provided with a computer program comprising program code means for performing the steps of any example embodiment of the method described hereinafter.

For controlling a vehicle platoon or an individual vehicle of the vehicle platoon when a vehicle is to change from one vehicle platoon to another vehicle platoon, preferably both the control unit 5 of the vehicle and the central control unit 10 are used in cooperation.

Alternatively or in addition to what has been described hereinabove, sensors can be arranged in the environment to the current road where the vehicle platoons are driven. These sensors may provide information received by the control unit 5 and/or the central control unit 10. Such sensors could be a complement to the sensors of the vehicles, giving further information and/or redundancy to the system.

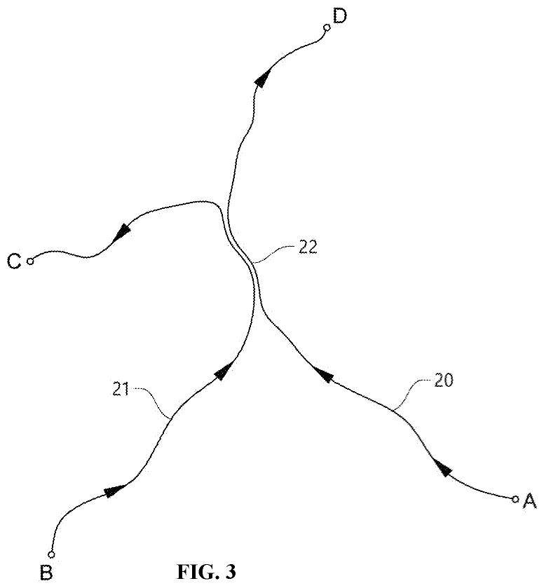

FIG. 3 is a simplified map showing some routes for vehicle platoons. In this example, a first vehicle platoon is driving from position A to position D along a first route 20, and a second vehicle platoon is driving from position B to position C along a second route 21. The first route 20 and the second route 21 have a road segment 22 in common. In this case, some following vehicles of the first vehicle platoon could however have position C as final destination, and some following vehicles of the second vehicle platoon could have position D as final destination.

When describing the method hereinafter, reference to FIGS. 1-3 will be made.

The method comprises the steps of providing the first vehicle platoon 1a driving along the first route 20 and the second vehicle platoon 1b driving along the second route 21. As previously described hereinabove, the first vehicle platoon 1a comprises a lead vehicle 2a and a plurality of following vehicles 3 and the second vehicle platoon 1b comprises a lead vehicle 2b and a plurality of following vehicles 3. The method further comprises the steps of selecting the road segment 22 in common to the first route 20 and the second route 21, and controlling at least one following vehicle 3a of the first vehicle platoon 1a to leave the first vehicle platoon and join the second vehicle platoon 1b, and/or controlling at least one following vehicle 3b of the second vehicle platoon 1b to leave the second vehicle platoon and join the first vehicle platoon 1a, while driving the first vehicle platoon 1a and the second vehicle platoon 1b along said road segment 22.

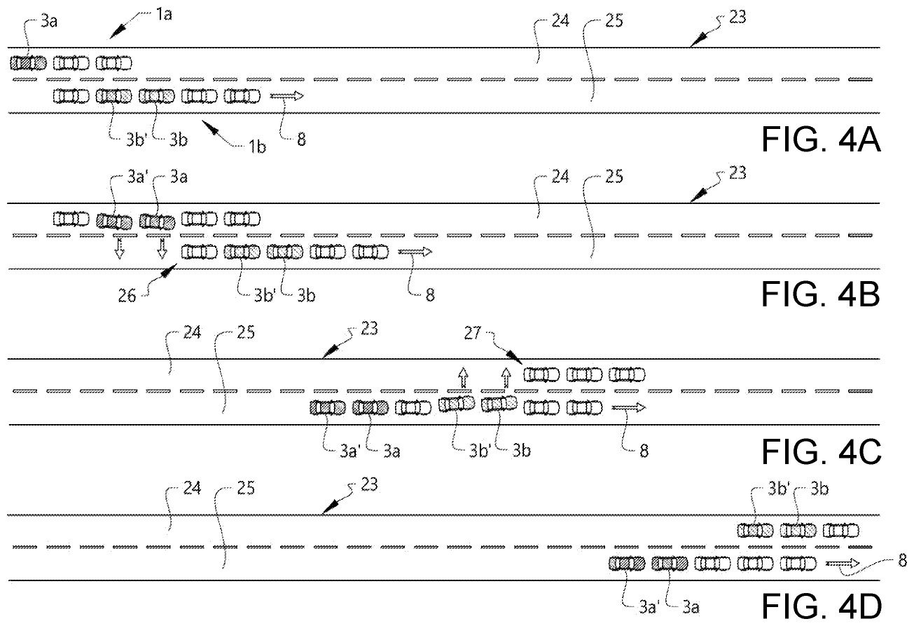

FIGS. 4A, 4B, 4C and 4D show an example embodiment of the method where sorting of vehicles is performed during overtaking. These figures show a part of the road segment 22 in common to the first route 20 and the second route 21. The road 23 of the road segment 22 comprises a first lane 24 and a second lane 25, which lanes preferably are dedicated for vehicle platoons only.

In the example embodiment illustrated in FIGS. 4A-4D, the method comprises the steps of driving the first vehicle platoon 1a in the first lane 24 of the road segment 22 and driving the second vehicle platoon 1b in the second lane 25 of the road segment 22, and positioning the first vehicle platoon 1a and the second vehicle platoon 1b relative to each other such that a rear end 26 of the second vehicle platoon 1b is in front of said at least one following vehicle 3a of the first vehicle platoon 1a, and controlling said at least one following vehicle 3a of the first vehicle platoon 1a to change from the first lane 24 to the second lane 25 and join the second vehicle platoon 1b at the rear end 26 of the second vehicle platoon 1b.

As indicated in FIGS. 4A and 4B, two following vehicles 3a, 3a′ of the first vehicle platoon 1a are disconnecting from the first vehicle platoon 1a and changing from the first lane 24 to the second lane 25 for connecting to the second vehicle platoon 1b. These following vehicles 3a, 3a′ are dark grey for illustration purposes only. The wording “connecting” and “disconnecting” to/from a vehicle platoon used herein, is referring to which lead vehicle the following vehicle will follow and the connection to any local network associated with the current vehicle platoon. The vehicles of the vehicle platoon are however individually driven vehicles as previously described hereinabove, though driven together as a group or convoy.

The method further comprises the steps of repositioning the first vehicle platoon 1a and the second vehicle platoon 1b relative to each other such that a rear end 27 of the first vehicle platoon 1a is in front of said at least one following vehicle 3b of the second vehicle platoon 1b, controlling said at least one following vehicle 3b of the second platoon 1b to change from the second lane 25 to the first lane 24 and join the first vehicle platoon 1a at the rear end 27 of the first vehicle platoon 1a.

As indicated in FIGS. 4C and 4D, two following vehicles 3b, 3b′ of the second vehicle platoon 1b are disconnecting from the second vehicle platoon 1b and changing from the second lane 25 to the first lane 24 for connecting to the first vehicle platoon 1a. These following vehicles 3b, 3b′ are grey for illustration purposes only.

The method can comprise the step of performing the lane change of said at least one following vehicle 3a of the first vehicle platoon 1a, and thereafter the lane change of said at least one following vehicle 3b of the second vehicle platoon 1b, during an overtaking where the first vehicle platoon 1a passes the second vehicle platoon 1b. In the example embodiment illustrated in FIGS. 4A-4D, during the sorting operation of the following vehicles the first vehicle platoon 1a has performed an overtaking relative to the second vehicle platoon 1b. After the sorting operation has been performed, the first vehicle platoon 1a and the second vehicle platoon 1b can proceed towards their destinations, as indicated in FIG. 4D.

It should be stressed that the sorting operations described herein are preferably performed by controlling the vehicles by means of the equipment and control units described with reference to FIGS. 1 and 2, without any assistance from any driver of any of the vehicles.

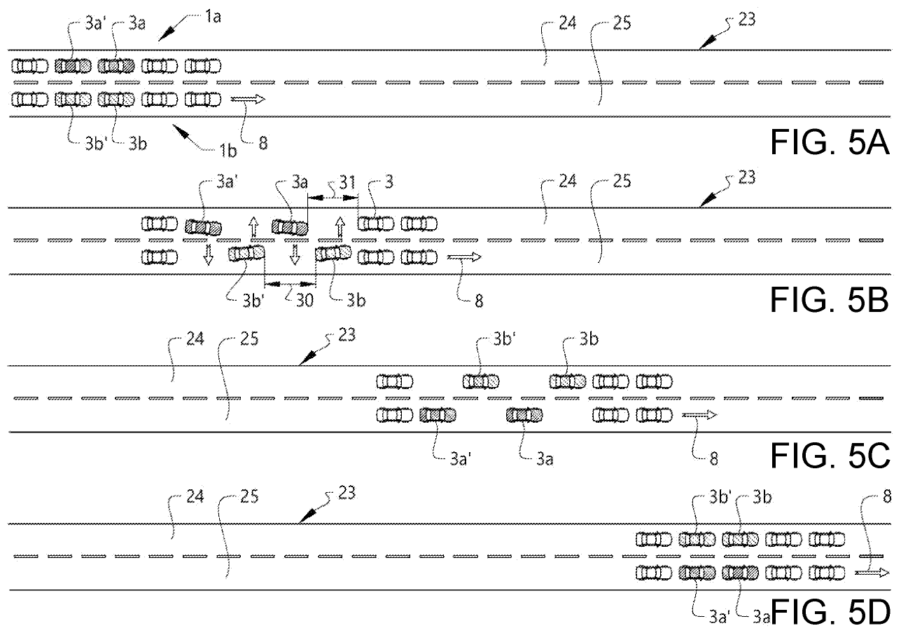

FIGS. 5A, 5B, 5C and 5D show another example embodiment of the method where sorting of vehicles is performed by zipper merging. These figures show a part of the road segment 22 in common to the first route 20 and the second route 21. The road 23 of the road segment 22 comprises the first lane 24 and the second lane 25, which lanes preferably are dedicated for vehicle platoons only.

In the example embodiment illustrated in FIGS. 5A-5D, the method comprises the steps of driving the first vehicle platoon 1a in the first lane 24 of the road segment 22 and driving the second vehicle platoon 1b in the second lane 25 of the road segment 22, side by side, providing a distance 30 between a first following vehicle 3b and a second following vehicle 3b′ of the second vehicle platoon 1b, for receiving a following vehicle 3a therebetween at a position corresponding to the longitudinal position (in the driving direction 8) of said at least one following vehicle 3a of the first vehicle platoon 1a, and controlling said at least one following vehicle 3a of the first vehicle platoon 1a to change from the first lane 24 to the second lane 25 and join the second vehicle platoon 1b between the first following vehicle 3b and the second following vehicle 3b′ of the second vehicle platoon 1b.

As indicated in FIGS. 5A and 5B, two following vehicles 3a, 3a′ of the first vehicle platoon 1a are disconnecting from the first vehicle platoon 1a and changing from the first lane 24 to the second lane 25 for connecting to the second vehicle platoon 1b. These following vehicles 3a, 3a′ are dark grey for illustration purposes only.

The method can also comprise the steps of providing a distance 31 between a first following vehicle 3 and a second following vehicle 3a of the first vehicle platoon 1a, for receiving a following vehicle 3b therebetween at a position corresponding to the longitudinal position (in the driving direction 8) of said at least one following vehicle 3b of the second vehicle platoon 1b, controlling said at least one following vehicle 3b of the second vehicle platoon 1b to change from the second lane 25 to the first lane 24 and join the first vehicle platoon 1a between the first following vehicle 3 and the second following vehicle 3a of the first vehicle platoon 1a.

The distances 30, 31 are adapted to the size of the vehicles and the time gap between the vehicles for performing the lane shift.

As also indicated in FIGS. 5A and 5B, two following vehicles 3b, 3b′ of the second vehicle platoon 1b are disconnecting from the second vehicle platoon 1b and changing from the second lane 25 to the first lane 24 for connecting to the first vehicle platoon 1a. These following vehicles 3b, 3b′ are grey for illustration purposes only.

The method can comprise the step of performing the lane change of said at least one following vehicle 3a of the first vehicle platoon 1a and the lane change of said at least one following vehicle 3b of the second vehicle platoon 1b by zipper merging said at least one following vehicle 3a of the first vehicle platoon 1a and said at least one following vehicle 3b of the second vehicle platoon 1b. In the example embodiment illustrated in FIGS. 5A-5D, during the sorting operation of the following vehicles, two following vehicles 3a, 3a′ of the first vehicle platoon 1a and two following vehicles 3b, 3b′ of the second platoon 1b have been controlled to perform a zipper merge operation. After the sorting operation has been performed, the first vehicle platoon 1a and the second vehicle platoon 1b can proceed side by side towards their destinations, as indicated in FIG. 5D.

The invention also relates a control arrangement 40 for controlling vehicles of vehicle platoons. When describing the control arrangement 40 hereinafter, reference is made to previously described figures, particularly FIGS. 1 and 2.

The control arrangement 40 preferably comprises one or more of the central control unit 10, control units 5 and communication units 6 arranged on the vehicles, and the sensor equipment 4 of the vehicles. For example, the central control unit 10 is suitably used for selecting the road segment 22, and the first vehicle platoon 1a and the second vehicle platoon 1b, between which vehicle platoons 1a, 1b one or more following vehicles are to be switched.

In analogy to what is described hereinabove as it regards the method, the control arrangement is configured to control the vehicle platoons 1a, 1b accordingly.

The control arrangement 40 is configured to select the road segment 22 in common to the first route 20 and the second route 21, and to control at least one following vehicle 3a of the first vehicle platoon 1a to leave the first vehicle platoon 1a and join the second vehicle platoon 1b, and/or control at least one following vehicle 3b of the second vehicle platoon 1b to leave the second vehicle platoon 1b and join the first vehicle platoon 1a, while the first vehicle platoon 1a and the second vehicle platoon 1b are driving along said road segment 22.

The control arrangement 40 can be configured to control the first vehicle platoon 1a driving in a first lane 24 of the road segment 22 and the second vehicle platoon 1b driving in a second lane 25 of the road segment 22, thereby positioning the first vehicle platoon 1a and the second vehicle platoon 1b relative to each other such that a rear end 26 of the second vehicle platoon 1b is in front of said at least one following vehicle 3a of the first vehicle platoon 1a, and to control said at least one following vehicle 3a of the first vehicle platoon 1a to change from the first lane 24 to the second lane 25 and join the second vehicle platoon 1b at the rear end 26 of the second vehicle platoon 1b.

Correspondingly, the control arrangement 40 can be configured to control the first vehicle platoon 1a and the second vehicle platoon 1b for repositioning the first vehicle platoon 1a and the second vehicle platoon 1b relative to each other such that a rear end 27 of the first vehicle platoon 1a is in front of said at least one following vehicle 3b of the second vehicle platoon 1b, and to control said at least one following vehicle 3b of the second vehicle platoon 1b to change from the second lane 25 to the first lane 24 and join the first vehicle platoon 1a at the rear end 27 of the first vehicle platoon 1a.

Further, the control arrangement 40 can be configured to control the first vehicle platoon 1a driving in a first lane 24 of the road segment 22 and control the second vehicle platoon 1b driving in a second lane 25 of the road segment 22, and to control a first following vehicle 3b and a second following vehicle 3b′ of the second vehicle platoon 1b, thereby providing a distance 30 between the first following vehicle 3b and the second following vehicle 3b′ of the second vehicle platoon 1b, for receiving a following vehicle 3a therebetween at a position corresponding to the longitudinal position (in the driving direction 8) of said at least one following vehicle 3a of the first vehicle platoon 1a, and configured to control said at least one following vehicle 3a of the first vehicle platoon 1a to change from the first lane 24 to the second lane 25 and join the second vehicle platoon 1b between the first following vehicle 3b and the second following vehicle 3b′ of the second vehicle platoon 1b.

Correspondingly, the control arrangement 40 can be configured to control a first following vehicle 3 and a second following vehicle 3a of the first vehicle platoon 1a, thereby providing a distance 31 between the first following vehicle 3 and the second following vehicle 3a of the first vehicle platoon 1a, for receiving a following vehicle 3b therebetween at a position corresponding to the longitudinal position (in the driving direction 8) of said at least one following vehicle 3b of the second vehicle platoon 1b, and configured to control said at least one following vehicle 3b of the second vehicle platoon 1b to change from the second lane 25 to the first lane 24 and join the first vehicle platoon 1a between the first following vehicle 3 and the second following vehicle 3a of the first vehicle platoon 1a.

It is to be understood that the present invention is not limited to the embodiments described above and illustrated in the drawings; rather, the skilled person will recognize that many changes and modifications may be made within the scope of the appended claims.

What is claimed is:

1. A method for sorting vehicles of vehicle platoons, comprising the steps of providing a first vehicle platoon driving along a first route and a second vehicle platoon driving along a second route, the first vehicle platoon comprising a lead vehicle and a plurality of following vehicles and the second vehicle platoon comprising a lead vehicle and a plurality of following vehicles, selecting a road segment in common to the first route and the second route, and controlling at least one following vehicle of the first vehicle platoon to leave the first vehicle platoon and join the second vehicle platoon, and/or controlling at least one following vehicle of the second vehicle platoon to leave the second vehicle platoon and join the first vehicle platoon, while driving the first vehicle platoon and the second vehicle platoon along said road segment.

2. The method according to claim 1, wherein driving the first vehicle platoon in a first lane of the road segment and driving the second vehicle platoon in a second lane of the road segment, and positioning the first vehicle platoon and the second vehicle platoon relative to each other such that a rear end of the second vehicle platoon is in front of said at least one following vehicle of the first vehicle platoon, controlling said at least one following vehicle of the first vehicle platoon to change from the first lane to the second lane and join the second vehicle platoon at the rear end of the second vehicle platoon.

3. The method according to claim 2, wherein repositioning the first vehicle platoon and the second vehicle platoon relative to each other such that a rear end of the first vehicle platoon is in front of said at least one following vehicle of the second vehicle platoon, controlling said at least one following vehicle of the second platoon to change from the second lane to the first lane and join the first vehicle platoon at the rear end of the first vehicle platoon.

4. The method according to claim 3, wherein performing the lane change of said at least one following vehicle of the first vehicle platoon, and thereafter the lane change of said at least one following vehicle of the second vehicle platoon, during an overtaking where the first vehicle platoon passes the second vehicle platoon.

5. The method according to claim 1, wherein driving the first vehicle platoon in a first lane of the road segment and driving the second vehicle platoon in a second lane of the road segment, side by side, providing a distance between a first following vehicle and a second following vehicle of the second vehicle platoon, for receiving a following vehicle therebetween at a position corresponding to the longitudinal position of said at least one following vehicle of the first vehicle platoon, controlling said at least one following vehicle of the first vehicle platoon to change from the first lane to the second lane and join the second vehicle platoon between the first following vehicle and the second following vehicle of the second vehicle platoon.

6. The method according to claim 5, wherein providing a distance between a first following vehicle and a second following vehicle of the first vehicle platoon, for receiving a following vehicle therebetween at a position corresponding to the longitudinal position of said at least one following vehicle of the second vehicle platoon, controlling said at least one following vehicle of the second vehicle platoon to change from the second lane to the first lane and join the first vehicle platoon between the first following vehicle and the second following vehicle of the first vehicle platoon.

7. The method according to claim 6, wherein performing the lane change of said at least one following vehicle of the first vehicle platoon and the lane change of said at least one following vehicle of the second vehicle platoon by zipper merging said at least one following vehicle of the first vehicle platoon and said at least one following vehicle of the second vehicle platoon.

8. A control arrangement for controlling vehicles of vehicle platoons, the vehicle platoons comprising a first vehicle platoon driving along a first route and a second vehicle platoon driving along a second route, the first vehicle platoon comprising a lead vehicle and a plurality of following vehicles and the second vehicle platoon comprising a lead vehicle and a plurality of following vehicles, the control arrangement being configured to select a road segment in common to the first route and the second route, and to control at least one following vehicle of the first vehicle platoon to leave the first vehicle platoon and join the second vehicle platoon, and/or control at least one following vehicle of the second vehicle platoon to leave the second vehicle platoon and join the first vehicle platoon, while the first vehicle platoon and the second vehicle platoon are driving along said road segment.

9. The control arrangement according to claim 8, wherein the control arrangement is configured to control the first vehicle platoon driving in a first lane of the road segment and the second vehicle platoon driving in a second lane of the road segment, thereby positioning the first vehicle platoon and the second vehicle platoon relative to each other such that a rear end of the second vehicle platoon is in front of said at least one following vehicle of the first vehicle platoon, and to control said at least one following vehicle of the first vehicle platoon to change from the first lane to the second lane and join the second vehicle platoon at the rear end of the second vehicle platoon.

10. The control arrangement according to claim 9, wherein the control arrangement is configured to control the first vehicle platoon and the second vehicle platoon, thereby repositioning the first vehicle platoon and the second vehicle platoon relative to each other such that a rear end of the first vehicle platoon is in front of said at least one following vehicle of the second vehicle platoon, and to control said at least one following vehicle of the second vehicle platoon to change from the second lane to the first lane and join the first vehicle platoon at the rear end of the first vehicle platoon.

11. The control arrangement according to claim 10, wherein the control arrangement is configured to control said at least one following vehicle of the first vehicle platoon to perform the lane change, and thereafter control said at least one following vehicle of the second vehicle platoon to perform the lane change, during an overtaking where the first vehicle platoon passes the second vehicle platoon.

12. The control arrangement according to claim 8, wherein the control arrangement is configured to control the first vehicle platoon driving in a first lane of the road segment and control the second vehicle platoon driving in a second lane of the road segment, and to control a first following vehicle and a second following vehicle of the second vehicle platoon, thereby providing a distance between the first following vehicle and the second following vehicle of the second vehicle platoon, for receiving a following vehicle therebetween at a position corresponding to the longitudinal position of said at least one following vehicle of the first vehicle platoon, and configured to control said at least one following vehicle of the first vehicle platoon to change from the first lane to the second lane and join the second vehicle platoon between the first following vehicle and the second following vehicle of the second vehicle platoon.

13. The control arrangement according to claim 12, wherein the control arrangement is configured to control a first following vehicle and a second following vehicle of the first vehicle platoon, thereby providing a distance between the first following vehicle and the second following vehicle of the first vehicle platoon, for receiving a following vehicle therebetween at a position corresponding to the longitudinal position of said at least one following vehicle of the second vehicle platoon, and configured to control said at least one following vehicle of the second vehicle platoon to change from the second lane to the first lane and join the first vehicle platoon between the first following vehicle and the second following vehicle of the first vehicle platoon.

14. The control arrangement according to claim 13, wherein the control arrangement is configured to control said at least one following vehicle of the first vehicle platoon to perform the lane change and control said at least one following vehicle of the second vehicle platoon to perform the lane change by zipper merging said at least one following vehicle of the first vehicle platoon and said at least one following vehicle of the second vehicle platoon.

15. A non-transitory computer readable medium storing a computer program code for performing the method according to claim 1.
